(19) United States
(12) Patent Application Publication
(10) Pub. No.: US 2013/0276648 A1
(43) Pub. Date: Oct. 24, 2013

(54) AGRICULTURAL PRESS FOR THE PRODUCTION OF ROUND BALES, HAVING ROLLERS DRIVEN BY ELECTRIC MOTORS

(71) Applicant: Mauro Zona, Torino (IT)

(72) Inventor: Mauro Zona, Torino (IT)

(73) Assignee: Zona Engineering & Design S.a.s. di Zona Mauro & C, Torino (IT)

(21) Appl. No.: 13/876,988

(22) PCT Filed: Sep. 27, 2011
(86) PCT No.: PCT/IB2011/054239

§ 371 Date: Jun. 11, 2013

(30) Foreign Application Priority Data
Sep. 29, 2010 (IT) TO2010A000795

(51) Int. Cl. A01F 15/07; A01F 15/18

(52) U.S. Cl. CPC A01F 15/07; A01F 15/18
USPC 100/86

(57) ABSTRACT

An agricultural press for forming round bales includes a plurality of rollers defining a pressing chamber, which are rotatably mounted partially on a load-bearing structure and partially on a structure that is articulated to the load-bearing structure and can be displaced into a raised position for unloading a round bale from the pressing chamber. The rollers are driven by electric motors, which, may be contained within the rollers or are of the type with hollow shaft, for receiving within them an end pin of the respective roller. The load-bearing structure and the structure articulated to the load-bearing structure are in the form of structures of the space-frame type with main lateral structures made of metal, preferably aluminium, obtained by casting.

### CROSS-REFERENCE TO RELATED APPLICATIONS

This application is a 371 National Phase of International Application Number PCT/IB2011/054239 filed on Sep. 27, 2011, and published in English on Apr. 5, 2012 as International Publication Number WO 2012/042466 A1, which claims priority to Italian Patent Application No. TO2010A000795, filed on Sep. 29, 2010, the entire disclosures of which are incorporated herein by reference.

### FIELD OF THE INVENTION

The present invention relates to agricultural presses for the production of round bales, of the type comprising a load-bearing structure mounted on wheels and a plurality of rollers arranged circumferentially about a central axis, with their axes parallel to said central axis so as to define a pressing chamber, wherein said rollers defining the pressing chamber are rotatably supported for a first part by said load-bearing structure and for a second part by a structure articulated to the load-bearing structure about an axis parallel to said central axis, said articulated structure being displaceable into a raised, position for unloading a round bale from the pressing chamber.

It should be noted that the invention applies both to presses of the fixed-chamber type, characterized by a ring of rollers that define a pressing chamber for formation of a bale having a single pre-set diameter, and to variable-chamber presses, in which belts are provided engaged on a limited number of rollers for formation of bales of an adjustable diameter.

### BACKGROUND OF THE INVENTION

In machines according to the known art, the load-bearing structure of the rollers of the pressing chamber is constituted by a frame in the form of a boxlike structure made up of elements of sheet metal welded and/or screwed together. The rollers of the machine are driven in rotation by means of a chain-transmission system, which is complicated and far from efficient and moreover entails periodic maintenance operations in order to adjust the tension of the chain and lubricate the various members of the transmission, as well as remove soil or mud from the casing containing the transmission. The ensemble of the various members of the machine is moreover subject to the risk of failure on account of the high pressure that is set up in the pressing chamber during operation.

### SUMMARY OF THE INVENTION

The object of the present invention is to overcome the aforesaid drawbacks by providing an agricultural press for the production of round bales that will have a structure that extremely simple, but at the same lime strong, reliable in operation, and such as to require a reduced number of maintenance operations.

With a view to achieving the above purpose, the subject of the invention is an agricultural press of the type referred to at the start of the present description, characterized in that said rollers are driven by electric motors. In a first preferred solution, each roller is equipped with a respective electric driving motor set inside the roller. According to a second solution, which is also preferred, each roller is equipped with a respective electric motor of the direct-drive type with a hollow central shaft connected in which is an end pin of the respective roller.

According to a further preferred characteristic, one or more rollers are rotatably mounted each on a respective end support, which can be slid out of a respective seat in a direction substantially orthogonal to the axis of the roller.

In a further preferred embodiment, both the aforesaid load-bearing structure and the aforesaid structure articulated to the load-bearing structure each comprise a pair of lateral metal structures, which are obtained by casting, are shaped substantially like ring portions, parallel to, and spaced apart from, one another, support the ends of the rollers of the pressing chamber, and are connected by a plurality of transverse elements.

Preferably, the aforesaid lateral structures obtained by casting are made of aluminium or alloys thereof. The ring portions that constitute the lateral structures of the load-bearing structure and of the structure articulated to the load-bearing structure are arranged on the extensions of one another so as to define substantially two complete rings in a condition where the articulated structure is lowered.

According to a further characteristic of the invention, the aforesaid lateral structures obtained by casting of said load-bearing structure incorporate in a single piece lateral walls for supporting a unit for gathering and feeding the produce to the pressing chamber. The aforesaid lateral structures of the load-bearing structure are also used for installation of an axle carrying the wheels of the agricultural press.

### BRIEF DESCRIPTION OF THE DRAWINGS

Further characteristics and advantages of the invention will emerge from the ensuing description with reference to the annexed drawings, which are provided purely by way of non-limiting example and in which:

FIG. 1 is a perspective view, with some parts exploded and/or removed, of an embodiment of the agricultural press that does not form part of the invention, but is useful for an understanding of some characteristics of the machine according to the invention;

FIG. 2 is a side view of the press of FIG. 1;

FIG. 3 is a perspective view of the main parts of the press of FIGS. 1 and 2;

FIG. 4 is a perspective view corresponding to that of FIG. 3, but with some parts removed for clarity;

FIG. 5 is a perspective view of a detail of an embodiment of the machine according to the invention;

FIG. 6 is a further perspective view of a detail of FIG. 5, in exploded view;

FIG. 7 is a sectioned view of the detail of FIG. 6, in the assembled condition; and

FIG. 8 illustrates a variant according to the invention of the solution illustrated in FIG. 5.

### DETAILED DESCRIPTION OF THE DRAWINGS

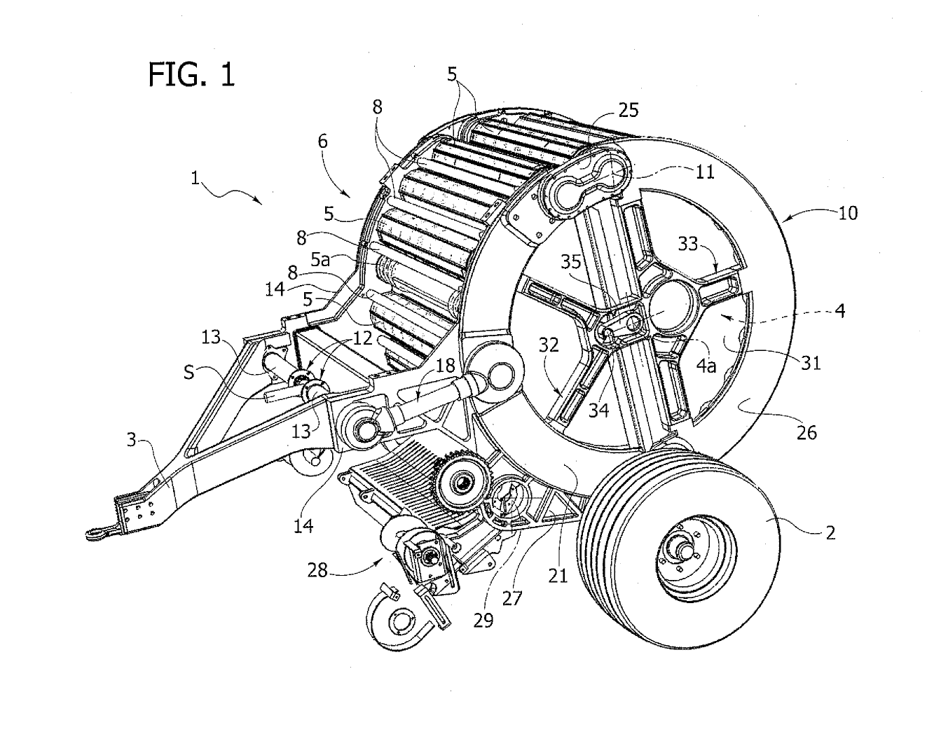

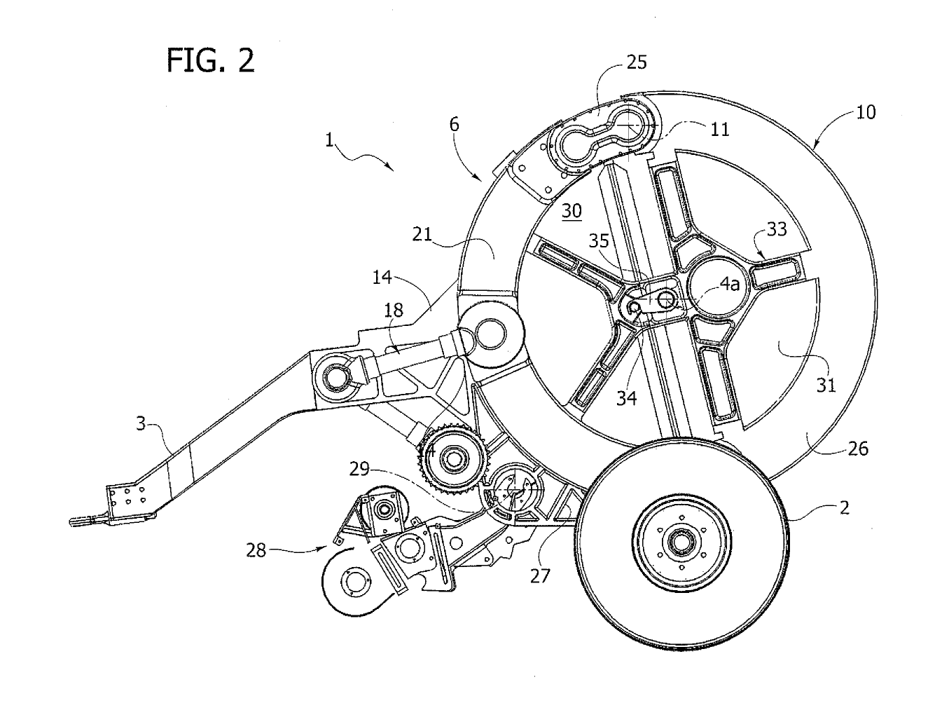

In FIGS. 1 and 2, the reference number 1 designates as a whole an agricultural press for the production of round bales. The press 1 comprises a load-bearing structure mounted on wheels 2 and connected to a front drawbar 3 for connection to an agricultural tractor. The press illustrated in FIGS. 1-4, as is evident from said figures, does not form the subject of the present invention in so far as it envisages gear transmissions, which, according to the present invention, are replaced by electric motors. However, the general structure of the press illustrated in FIGS. 1-4 is also envisaged in the preferred embodiment of the invention (except that the gear transmission is replaced by electric motors) and for this reason is in any case described in detail in what follows.

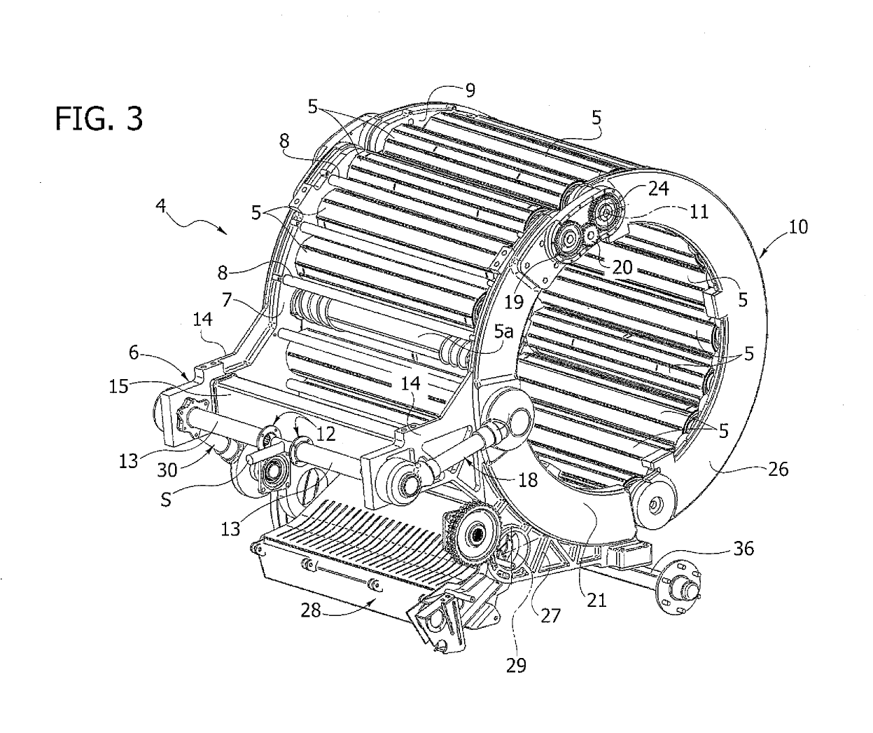

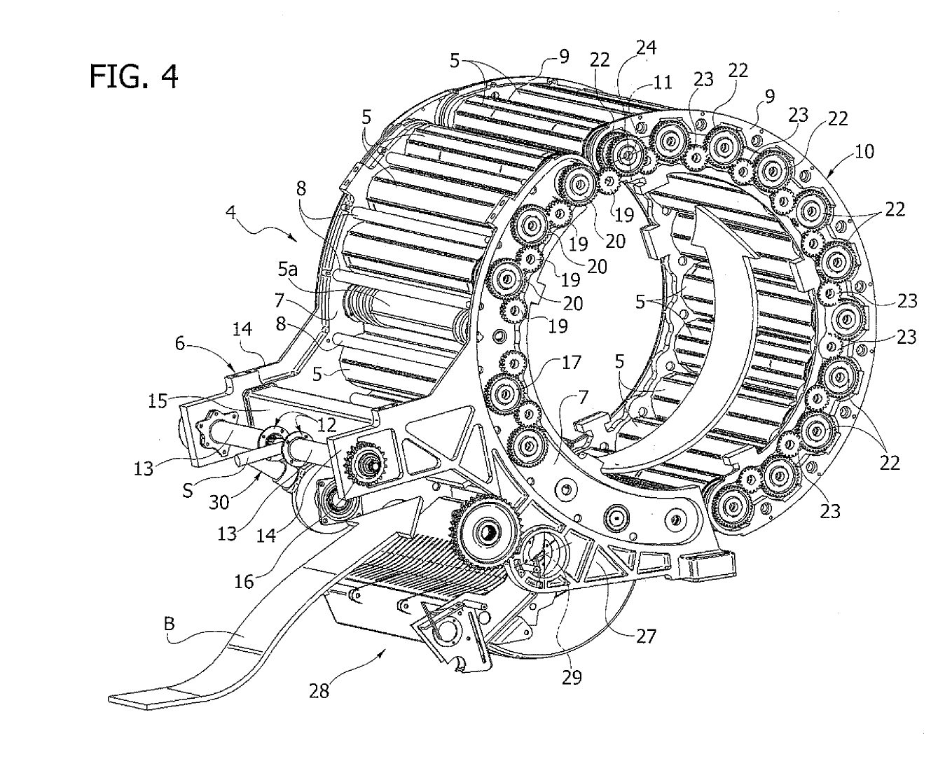

The press 1 comprises a pressing chamber 4 (see also FIGS. 3, 4) of a substantially cylindrical shape, having a central axis 4a (see FIG. 2) parallel to the axis of the wheels 2. The pressing chamber 4 is defined by a plurality of rollers 5 arranged circumferentially about the central axis 4a, with their axes parallel to said axis.

The solutions illustrated in the annexed drawings all refer to presses of the fixed-chamber type, capable of producing round bales of a single pre-set diameter. It should be noted, however, that the invention also applies to presses of the variable-chamber type, comprising just a limited number of rollers that have the purpose of engaging belts that define the pressing chamber and that enable adjustment in a given range of the diameter of the round bales to be produced. Even though the ensuing description and the annexed drawings refer only to machines of the fixed-chamber type, the teachings of the present invention can be immediately applied also to machines of the variable-chamber type.

According to a characteristic that is likewise envisaged in the preferred embodiment of the invention, the agricultural press 1 comprises a load-bearing structure designated as a whole by the reference number 6, comprising two main lateral structures 7 (see FIG. 4), made of metal material, preferably aluminium or an alloy thereof, which are obtained by casting and are substantially shaped like ring portions centred on the central axis 4a. Said lateral structures 7 obtained by casting are substantially arranged in two planes orthogonal to the axis 4a of the pressing chamber, parallel to, and spaced apart from, one another. They rotatably support the ends of a plurality of rollers 5 of the pressing chamber. The two lateral load-bearing structures 7 obtained by casting are moreover connected together by a plurality of transverse elements 8, which in the example illustrated are in the form of cylindrical bars, for example via screwing.

The rollers 5 of the pressing chamber are carried in part by the aforesaid lateral structures 7 of the load-bearing structure 6 and in part by two further lateral structures 9 of a structure 10 articulated to the load-bearing structure 6 about a transverse axis 11 set adjacent to a top end of the load-bearing structure 6.

The structure 10 articulated to the load-bearing structure 6 can be raised into a position (not illustrated) where the pressing chamber is open to enable unloading on the ground of a round bale after it has been formed. Also the articulated structure 10 has a configuration similar to that of the load-bearing structure 6 with the two main structures 9 constituted by metal castings, preferably made of aluminium or an alloy thereof, in the form of ring portions that are arranged on the prolongation of the ring portions defined by the lateral structures 7 of the load-bearing structure 6 so as to define two complete rings, as is clearly visible in FIG. 4. Also the structures 9 are connected together by transverse elements of the same type as the elements 8 shown in FIGS. 3 and 4 that connect the lateral structures 7.

In the case of the solution of FIGS. 1-4, which, for this reason, does not from part of the invention, rotation of the rollers 5 is governed by a transmission system that includes a transmission shaft S extending in a longitudinal direction, having a front end (not visible in the drawings) that is to be connected to the power take-off of an agricultural tractor in order to be driven in rotation by the engine of the tractor. The shaft S has a rear end thereof connected by means of bevel-gear pairs 12 to two transverse shafts, which are rotatably mounted within axle casings 13. The latter are supported by two lateral supporting walls 14 that project at the front of the lateral structures 7 and are made of a single cast piece therewith. To provide further strengthening of the structure, the aforesaid lateral walls 14 that project from the lateral structures 7 are connected together by a boxlike cross member 15.

An end of one of the transverse shafts driven by the transmission shaft 11 carries a gear 16, which is connected to a first gear 17 connected in rotation to one of the rollers 5 carried by the load-bearing structure 6 (see FIG. 4). The device for transmission between the gear 16 and the gear 17 is contained in a casing 18 (FIGS. 1-3) and comprises a transmission shaft, the ends of which are connected in rotation by means of bevel gears to the two gears 16, 17.

In the case of the example illustrated in FIG. 4, each of the rollers 5 carried by the load-bearing structure 6 is connected in rotation to a respective gear 19 (see FIG. 4). The gears 19 are connected together in concordant rotation by means of idle gears 20 set between them.

FIGS. 1, 3, 4 also show that the load-bearing structure 6 supports a roller 5a having the function of feeding a mesh for binding the round bale in the direction indicated by the arrow A illustrated in FIG. 1.

To return to FIG. 4, the series of gears 17, 19, 20 that transmits motion to the rollers 5 carried by the load-bearing structure 6 is contained in a casing that is hermetically closed by a lid 21 (see FIGS. 1-3) and is made of a single piece with one of the two lateral structures 7 forming part of the load-bearing structure 6 constituted by an aluminium casting.

The structure 10 that, is articulated to the structure 6 comprises a gear transmission arranged on the prolongation of the gear transmission 17, 19, 20. Each of the rollers 5 carried by the articulated structure 10 has a respective gear 22 connected in rotation therewith, and idle gears 23 are provided between adjacent gears 22, which enable transmission in series of rotation from one roller 5 to another.

Provided on the axis of articulation 11 is a roller 5, which, in addition to the respective gear 22, has an auxiliary gear 24 (FIGS. 3, 4), which is driven in rotation by an idle gear 20, mounted inside an auxiliary casing 25 (FIGS. 1, 2), carried at the top end of the respective lateral structure 7 of the load-bearing structure 6. The auxiliary gear 24 is driven in rotation, via the aforesaid idle gear 20, by a last gear 19 of the series of gears carried by the load-bearing structure 6. On the opposite side, the load-bearing structure 6 envisages a similar casing 25, both of the casings 25 being used for hinging of the articulated structure 10.

Also the succession of gears 22, 23 associated to the articulated structure 10 is contained in a casing, which is closed in a sealed way by a lid 26 (FIGS. 1-3) and is made of a single cast piece with the respective lateral structure 9.

The lateral structures 7 of the load-bearing structure 6, which are made of aluminium and obtained by casting, also incorporate in a single piece two further front lateral walls 27, which have the function of providing articulation for a unit 28, in itself of a known type, for gathering and feeding the produce to the feed chamber (in the direction indicated by the arrow B of FIGS. 1 and 4). With reference to FIG. 2, the reference number 29 designates the axis of articulation of the gathering and feeding unit 28 to the front lateral walls 27 of the load-bearing structure 6.

The two lateral structures 7 forming part of the load-bearing structure 6 and the two lateral structures 9 forming part of the articulated structure 10 consequently constitute, together with the transverse structures 8, 15 that connect them together, a sort of structure of the space-frame type, preferably made of aluminium, which incorporates in a single piece the casings of the gear transmissions 19, 20 and 22, 23 and likewise incorporates in a single piece the walls 14, 27 for supporting the driving transmission and the unit 28 for gathering and feeding the produce.

With reference to FIGS. 3 and 4, the lateral wall 14 represented further to the left in the figures carries a casing 30 of a transmission that receives the motion from one of the transverse shafts driven by the shaft S and transmits it to a transverse drive shaft of the gathering and feeding unit 28. The transmission contained in the casing 30 comprises, in a way similar to the transmission contained in the casing 18, a transmission shaft the ends of which are connected in rotation by means of bevel-gear pairs to gears mounted on the connected transverse shafts.

Fixed to the two lateral structures 7 of the load-bearing structure 6 and to the two lateral structures 9 of the articulated structure 10 are lateral walls made of sheet metal 30, 31 substantially in the form of semicircles that close the pressing chamber laterally. In addition, as a further reinforcement of the structure, provided within the rings defined by the lateral structures 7, 9 are reinforcement lattices 32, 33, which carry, respectively, a pin 34 and an articulated hook 35 designed to engage mutually in order to block the articulated structure 10 in its lowered condition. In said condition, the pressing chamber is blocked in a closed condition and the produce fed by the unit 28 in the direction of the arrow B visible in FIGS. 1 and 4 is set in rotation within the chamber until the round bale is formed and is bound by means of a mesh fed in by the roller 5a. After formation of the round bale, the hooks 31a provided on the two sides of the pressing chamber are opened, and the structure 10 is raised to enable unloading of the round bale on the ground.

As may be seen in FIG. 3, the lateral structures 7 forming part of the load-bearing structure 6 are also used for installation of the axle 36 carrying the wheels 2 of the machine.

The foregoing description regards an embodiment that does not form part of the present invention, in which the transmission means associated to the lateral structures 7 and 9 are constituted by a gear transmission.

The invention described herein applies also to the case where, instead of a ring of rollers 5 of the type described above, the lateral structures of the load-bearing structure and of the articulated structure of the machine carry a limited number of rollers that have the purpose of engaging belts that define a pressing chamber of variable width, which enables round bales of adjustable diameter to be obtained.

In the case of the preferred embodiment according to the invention, the press has once again a load-bearing structure of the space-frame type as described above, obtained by casting, with a similar structure articulated to the load-bearing structure, but in this case, rotation of the rollers 5 of the pressing chamber (which may be of the fixed-volume or variable-volume type) is driven by means of electric motors present onboard the press.

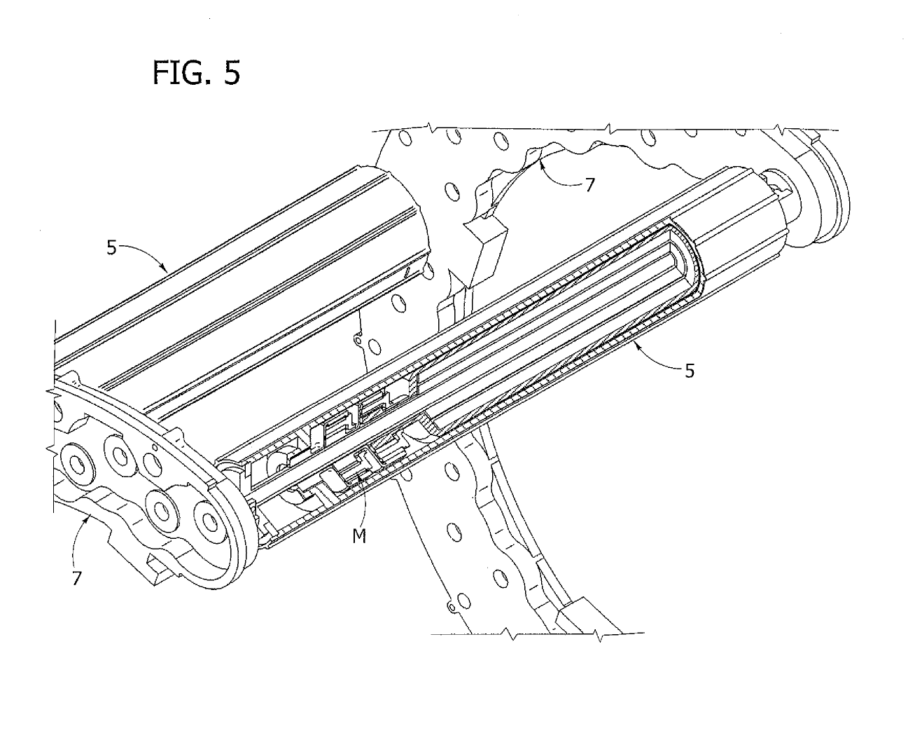

In general it may be envisaged that at least part of the rollers of the pressing chamber is driven by means of one or more electric motors, but, according to the preferred solution, one electric motor is provided for each roller of the pressing chamber. A particularly preferred embodiment envisages providing an electric motor M inside each roller 5, as may be seen in FIG. 5, so that, each roller 5 becomes a motor-roller. Motors suitable for a use of this type are already known and available on the market.

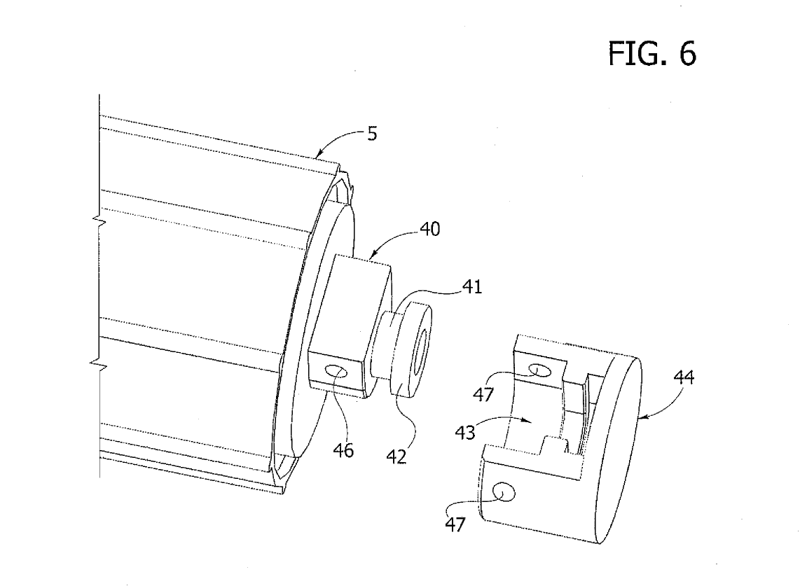

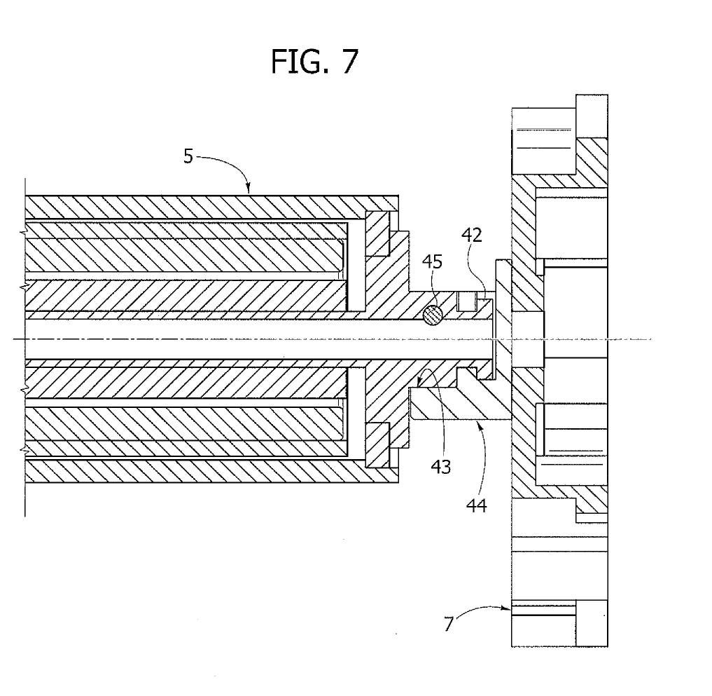

In the solution illustrated in FIGS. 5-7 there is moreover envisaged the possibility of removing in a fast way each roller 5 from the lateral structures 7 and 9 that support it in so far as each end of the roller 5 is rotatably supported on a shaped body, which is received in a seat 43 in such a way that it can be slid out in a direction substantially perpendicular to the axis of the roller. In the example illustrated, the aforesaid shaped body comprises a prismatic body 40 with a cylindrical axial pin 41 terminating in a widened cylindrical head 42. The seat 43 is of a complementary shape and is made in a support 34 fixed to the respective lateral structure 7 or 9. Blocking to prevent the body from sliding out of the seat 43 is obtained by means of engagement of a transverse pin 45 (FIG. 7) through mating holes 46 and 47 of the support 44 and of the prismatic body 40, as may be seen in FIGS. 6, 7.

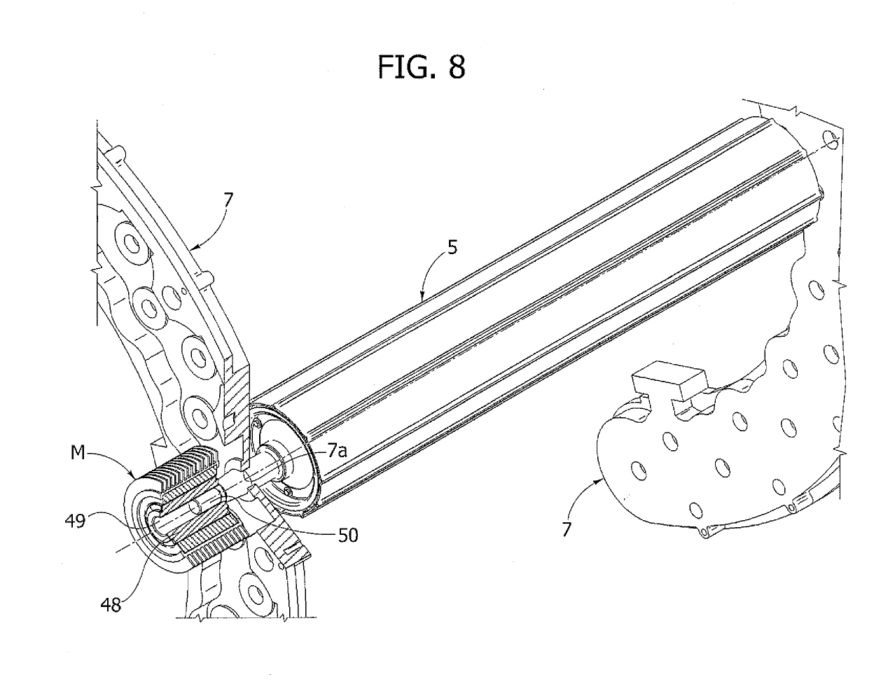

Of course, the coupling illustrated in FIGS. 5-7 can be used both with reference to the solution with motor-rollers of the type illustrated in FIG. 5 and with reference to the rollers 5 of the embodiment of FIGS. 1-4, as likewise in the case of the solution illustrated in FIG. 8.

FIG. 8 illustrates a final variant of electric motor drive for the rollers 5, in which each roller 5 has an end pin 50, which is rotatably received within a support 7a of the respective lateral structure 7 or 9 and is moreover connected in rotation inside an axial cavity 52 of a tubular shaft 53 of an electric motor M of the direct-drive or torque type.

Of course, without prejudice to the principle of the invention, the details of construction and the embodiments may vary widely with respect to what is described and illustrated herein purely by way of example, without thereby departing from the scope of the present invention.

1. Agricultural press for forming round bales, comprising:
a supporting structure, mounted on wheels,
a plurality of rollers arranged circumferentially around a central axis, with their axes parallel to said central axis, so as to define a pressing chamber,
wherein a first plurality of said rollers defining the pressing chamber is rotatably supported on said supporting structure and a second plurality of said rollers is rotatably supported on a structure articulated to the supporting structure around an axis parallel to said central axis, said articulated structure being movable to a raised position for unloading a round bale from the pressing chamber, and
wherein said rollers are driven by electric motors.

2. Agricultural press according to claim 1, wherein at least some of said rollers are driven each by a respective electric motor.

3. Agricultural press according to claim 2, wherein the electric motor driving each roller is arranged inside the roller.

4. Agricultural press according to claim 10, wherein the electric motor driving each roller is an electric motor with a hollow central shaft within which there is connected an end pin of the respective roller.

5. Agricultural press according to claim 1, wherein one or more rollers are rotatably mounted each on a respective end support which can be removed from a respective seat along a direction substantially orthogonal to the axis of the roller.

6. Agricultural press according to claim 1, wherein the supporting structure and the structure articulated to the supporting structure are metal structures each comprising two main lateral structures formed by casting, substantially shaped as ring portions and parallel to, and spaced apart from, each other, and supporting the ends of the rollers of the pressing chamber are connected to each other by a plurality of cross-elements.

7. Agricultural press according to claim 6, wherein the ring portions forming the lateral structures of the supporting structure and the structure articulated to the supporting structure are arranged on the extensions of each other, so as to define substantially two complete rings in a lowered condition of the articulated structure.

8. Agricultural press according to claim 6, further comprising a unit for picking up and feeding the produce to the pressing chamber, wherein the main lateral structures of said supporting structure include in one piece lateral walls for supporting said pick-up and feeding unit.

9. Agricultural press according to claim 1, wherein the main lateral structures of said supporting structure are rigidly connected to the housing of an axle carrying the wheels of the agricultural press and oriented parallel to the rollers of the pressing chamber.
